(19) United States
(12) Patent Application Publication
(10) Pub. No.: US 2012/0303458 A1
(43) Pub. Date: Nov. 29, 2012

(54) GPS CONTROLLED ADVERTISING IMAGES ON TRUCKS

(76) Inventor: John H. Schuler, JR., Atlanta, GA (US)

(21) Appl. No.: 13/482,947

(22) Filed: May 29, 2012

Related U.S. Application Data
(60) Provisional application No. 61/490,230, filed on May 26, 2011.

(51) Int. Cl. G06Q 30/02; B60Q 1/00; B60Q 1/34

(52) U.S. Cl. 705/14.63; 340/475; 340/425.5; 705/14.62

(57) ABSTRACT

A system and method for displaying digital messages and images on a flat screen on the back and sides of a moving vehicle using GPS with an antenna, controller with a memory, wireless receiver and transmitter for communicating with an external controller. The system has software programmed to change the display based upon a geo-fenced area. The display may have a section for displaying brake lights and turn signals and public announcements. The system may have a vehicle counter to determine the number of potential viewers of the display on the flat screen in order to establish a rate for an advertiser to pay per thousand potential viewers.

### CROSS-REFERENCE TO RELATED APPLICATIONS

This application claims priority to Provisional Application No. 61/490,230, filed on May 26, 2011 and entitled GPS CONTROLLED ADVERTISING IMAGES ON TRUCKS, which is hereby incorporated by reference herein in its entirety.

### SUMMARY OF INVENTION

This invention relates to a system and method for displaying advertising on the back or side of any moving vehicle, such as the trailer of a tractor trailer rig or bus or taxi, and periodically changing the advertising based upon the GPS information or other information received by the controller. A geo-fence may be used to determine when the advertisement should be changed.

### BRIEF DESCRIPTION OF THE DRAWINGS

FIG. 1 is the top view of the trailer of a tractor trailer rig illustrating the GPS, antenna and cable with the external devices portion of the system of this invention.

FIG. 2 is a schematic view of the back doors of a trailer of a tractor trailer rig, where two electronic displays have been located with messages displayed.

FIG. 3 is a schematic view of the back of a trailer with a of a tractor trailer rig with a single electronic display of a message.

FIG. 4 is block diagram of the external device portion of the system shown in FIG. 1.

### DETAILED DESCRIPTION OF THE PREFERRED EMBODIMENT OF THIS INVENTION

The system and method of this invention relate to displaying advertising or other information on the back or side of any moving vehicle, such as the trailer of a tractor trailer rig or on a bus or taxi, and periodically changing the advertising or message based upon GPS or other information from the controller, which is located on the trailer or tractor, or a central controller located at a different location.

### PARTS LIST

The following lists the parts of the invention shown in the drawings:
10—Top view of the top of a trailer;
12—Wireless card and antenna;
14—Controller;
16—Cable from the router to display screen;
16—A & B Cable to each display screen;
18—Back of trailer;
19—A & B Doors on back of trailer;
20—A & B Digital flat screen;
22—A & B messages displayed on screens;
24—Locking apparatus for locking the doors on the trailer;
26—A & B Cable connecting to flat screens 20 A & B;
28—A & B Location on screen for stop light and public service announcement;
30—Wide flat screen;
32—External devices;
34—12 Volt DC battery;
36—External inverter.

Basically, the trailer may have a wireless card and antenna 12 for connecting to a satellite for GPS as shown in FIG. 1 and local wireless tower (not shown), such as used by cell phones. The antenna must be able to send and receive signals with the GPS satellites and also with cell towers. The system has a controller 14 or processor to send messages via a cable 16 to cables 16 A & B to the two screens 20 A & B on the back 18 of the trailer of a tractor trailer rig. Screens 20 A and B can carry the same or different messages. The messages displayed can be stored in the memory of the controller 14 or transmitted from a central computer or advertiser's computer wirelessly via cell towers to the controller 14 for displaying and storing in the memory of the controller.

A typical trailer of a tractor trailer rig has two back doors 19 A & B or a roll-up door on the back 18 of the trailer. These two doors are typically opened, closed and locked by a locking apparatus 24 for locking the doors on a trailer. In FIG. 1, flat screens 20 A & B are located on both sides of the locking apparatus 24 to avoid interfering with the opening and closing of the doors 19 A & B on the back 18 of the trailer. The digital flat screens 20 A & B can be attached to doors 19 A & B on the back of the trailer by any convenient means such as bolts, screws or other means. Stabilizers, like the shock absorbers on a car or truck, can be used to prevent the screens 20 A & B from vibrating which could damage the screen and make it difficult for a read. The stabilizers could be placed around each bolt or be built into each door 19 A & B or built into the screen itself, preferable near where the bolt or screws attach to the screens. Stabilizers also protect the screens from damage as the doors 19 A & B are opened and closed, often with a great deal of force.

The display screens can be LED or other types of digital screen. The surface of these screens can be constructed to have the appearance of cloth or any other desired texture.

The screens 20 A & B could be built into the back doors 19 A & B when the trailer is being constructed or as a later remodel of the trailer. Stabilizers could be placed in the doors at that time.

The controller 14 can be connected to the screens 20 A & B by a cable 16 which can run along the top of the trailer as shown in the top view 10 of the trailer shown in FIG. 1. The cable 16 is separated into two cables 16 A & B to attach to each display screen 20 A & B. It is preferable that the cables 16 A & B be attached near where the hinges (not shown) of the doors 19 A & B are attached. These hinges are usually on the outside side of the doors. These cables need to be of sufficient length to avoid being broken or damaged when the doors are opened and closed.

The controller 14 could be connected wirelessly to the display screen. The controller can be located on the top of the trailer as shown in FIG. 1 or at any other convenient location on the tractor trailer rig including in the tractor. The controller 14 is preferably located within or on the trailer as it often hitched to different tractors. The controller 14 has a memory for storing messages and other information for displaying messages. The messages to be displayed can be stored in the controller before the trailer starts its journey or can be conveyed wirelessly during the journey and stored in the controller 14.

The controller 14, in the present invention, may be a commercially available stand alone PC equipped with an input for receiving image data, an internal or external storage device, and one or more image outputs to send to the screens 20 A & B. The controller 14 also has a central processing unit that performs the calculations and logic necessary to carry out the programming instructions received from the software. The controller 14 needs to have a GPS interface. The controller 14 may also include read only memory and random access memory. The controller 14 has the main functions of receiving and following programming instructions; receiving and storing image data; and coordinating image data presentation to associated image displays. All these functions may be programmed into software and run on a standard PC computer. Programming instructions are stored in the memory of controller 14 as computer executable code. The programming instructions, when followed, instruct the controller 14 to send image data to flat display screens 20 A & B. The instructions may also determine the duration image data is displayed and when new image data should be started. The instructions may also incorporate input from a GPS system and sending image data to flat screens 20 A & B when the geographic location changes. The programming instructions may also be overridden by new live programming in the event of an emergency. The controller 14 also receives and stores display data. By following the programming instructions, the controller 14 selects display data from the memory of the controller and sends it to the appropriate flat screen 20 A & B.

A central computer (not shown) can change the messages to be displayed on the screens 20 A & B during the journey by conveying a new message to the controller 14 for display. The images and messages to be displayed can be loaded wirelessly by the central computer or loaded before the trailer starts it trip by being wired to a central computer.

Software is installed in the controller 14 for changing the messages displayed on the screens 20 A & B based upon the geographic location of the trailer as determined by the GBS satellite (not shown) as related to the controller 14 via the wireless card and antenna 12 to which the controller is attached.

Typically, the advertiser or firm that wants the message displayed will specify the geographic area in which it is to be displayed. For example, a restaurant in town X along the route will want the message displayed from about 75 miles before the exit to the restaurant to the location of the exit. The software can be created to allow the display of the message on one or both screens 20 A & B while the trailer is travelling this distance. This software can be programmed to permit the central computer to override this instruction and to run the message for a shorter distance. The software can be programmed to allow the driver to vary the time or distance the message is displayed on one or both screens 20 A & B. Preferably, the screen messages will be centrally controlled and not by the driver. The central computer can change the message displayed for any one of a number of reasons, such as the restaurant is closed or it is offering specials which the restaurant wants to be displayed.

In the case of chain business, such as chain restaurants, the software can be programmed to list the exits for the locations for such businesses for 100 or more miles along the route to be travelled by the trailer. The software can be programmed to alternate messages on the screens 20 A & B from time to time. The software can be programmed to display a different message on screens A and B or to display two or more messages on each screen.

The software can programmed to create a geo-fence for changing a message. A geo-fence is a virtual perimeter for a real-world geographic area. For example, this fence may start 100 miles from the exit where the business is located and end 1 mile from the location or exit for the business. The geo-fence would normally be established around the road the trailer is expected to travel on this trip and limited to area where the advertiser or business wants the message to be displayed on the flat screen 20 A & B. This perimeter of the geo-fence can be changed by controller 14 or the central computer as the trailer is travelling the route. The central computer will keep track of the location of the trailer through the controller 14 on the trailer. If the tractor trailer has to change routes, the central computer can reprogram the messages, simply delete those that are not applicable to the different route, or run a different message. The controller 14 can be programmed to automatically send a message, ping, of the trailer's location every so often, such as every 5 or 10 minutes, to the central computer or other computer located on the ground.

When the trailer enters or exits a geo-fence area, the controller 14 receives a generated notification, which may sent from the central computer, advertiser's computer or email account or mobile phone based upon the software being used. If the trailer leaves a geo-fence area, the software can be programmed to notify the central computer which may indicate the trailer was stolen or taken off course.

The controller 14 can be programmed to display a fall back advertisement or message if there is no GPS coverage for an area or where no advertisement has been selected for an area.

The software can be programmed so that a message will remain on the screen 20 A or B for a certain minimum time that it requires a person travelling behind the trailer to read and remember. This may be a minimum period of 5 to 10 seconds. A repeat of the message may be need to be made in another 10 seconds or so for a person to remember the message. These periods can be determined by experimentation with subjects viewing messages in a laboratory or on road.

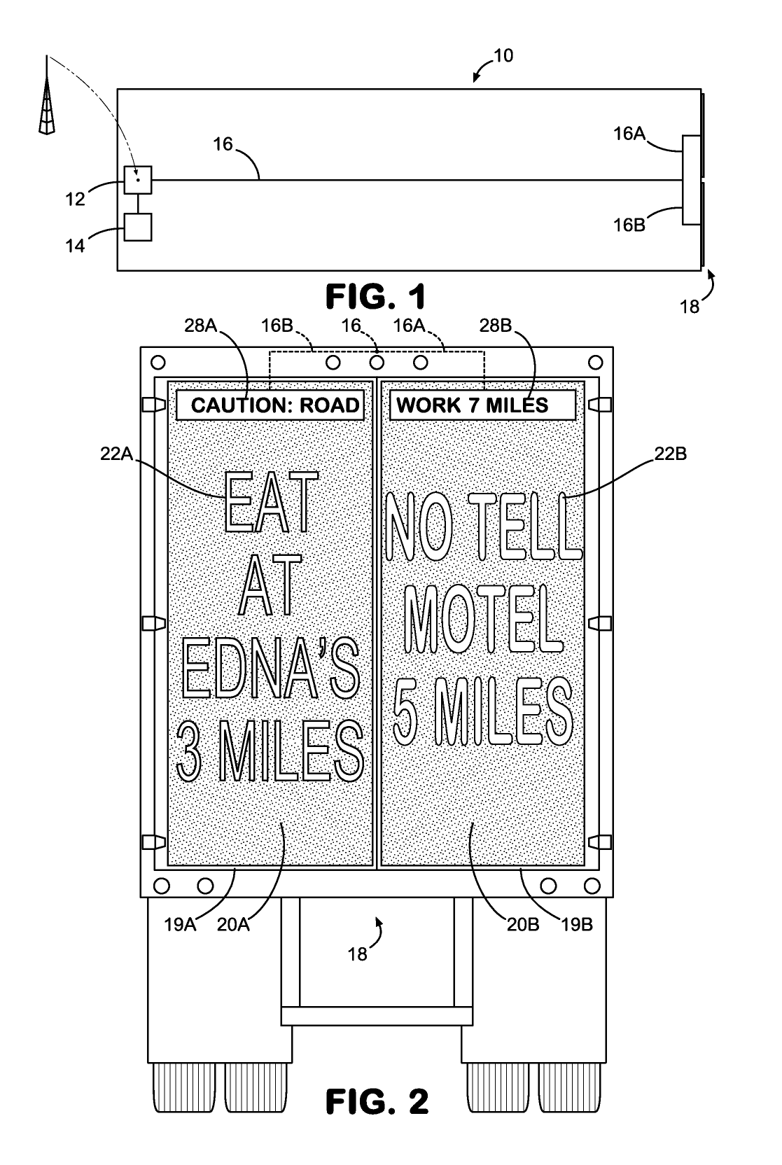

An optional feature of this system is to provide for the showing of brake lights and turn signals on the display screens 20 A & B. It can also display a yellow light to indicate the trailer is slowing down. As shown in FIG. 2 this can be accomplished near the top of the screen at locations 28 A & B across both screens. It may be that another location will be more desirable based upon experimentation and the desire of truckers and advertisers.

This same location or another location on display screens 20 A & B can be selected for displaying public service announcements in a geo-fenced area with a defined radius, such as lookout announcements for a certain vehicle that may be involved in kidnapping of a child, alert for missing disabled or elderly people (Mattie's call), amber alerts, traffic congestion, or impending weather announcements. These messages could be displayed as video messages or involve movement such as weather radar, photographs and other types of full motion video. Making provision for public service announcements may alleviate concern about the messages being distractive to drivers seeing the messages.

While this system is especially attractive to business firms, it can be used for governmental or eleemosynary messages as well.

This system lends itself to charging advertisers based upon the number of viewers as is the case with TV advertisements which are typically charged based upon Nielsen ratings of viewer for the past year. Advertisements on the internet are many times paid for by the number of hits on the advertisements by internet users. A similar system can be employed with the system of this invention. An electronic sensor that counts the number of vehicles that has viewed the message can be installed on the trailer with the controller programmed to record that count within the geo-fence for a particular advertisement. The charge for each vehicle where the occupants had a chance to view the advertisement can be determined in advance of the business or advertiser entering into the contract to display the advertisement. The charge for each vehicle can be determined from past experience on the effectiveness of advertisements as it is with the internet advertisements.

The vehicle counter can be based upon radar, infrared, or visual technology. The vehicle count can be transmitted to the controller from the vehicle counter by a cable and then transmitted wirelessly to a central computer and used to compute the charge of the advertisement displayed in a particular geo-fenced area.

Alternatively, the traffic count used by government areas for traffic at different times and days can be used to determine the price of displaying the advertisement in this geo-fenced area for the time and day the trailer passes through the area. Independent rating agencies, such as the Nielsen Company, can be used to maintain a pulse on the activities of viewers and help determine the price of the ads.

A light sensor can be installed with a microprocessor to change the light intensity of the advertisement. The software in the controller can be programmed to do this under certain condition, such as dimming the lights at night when the display might interfere with traffic.

Demographic data may be loaded into the controller 14 so that the light is reduced in heavily populated areas, such as towns and cities. The driver of the tractor-trailer may be given the right to turn the lights down, which he or she may do in certain populated areas or under other circumstances.

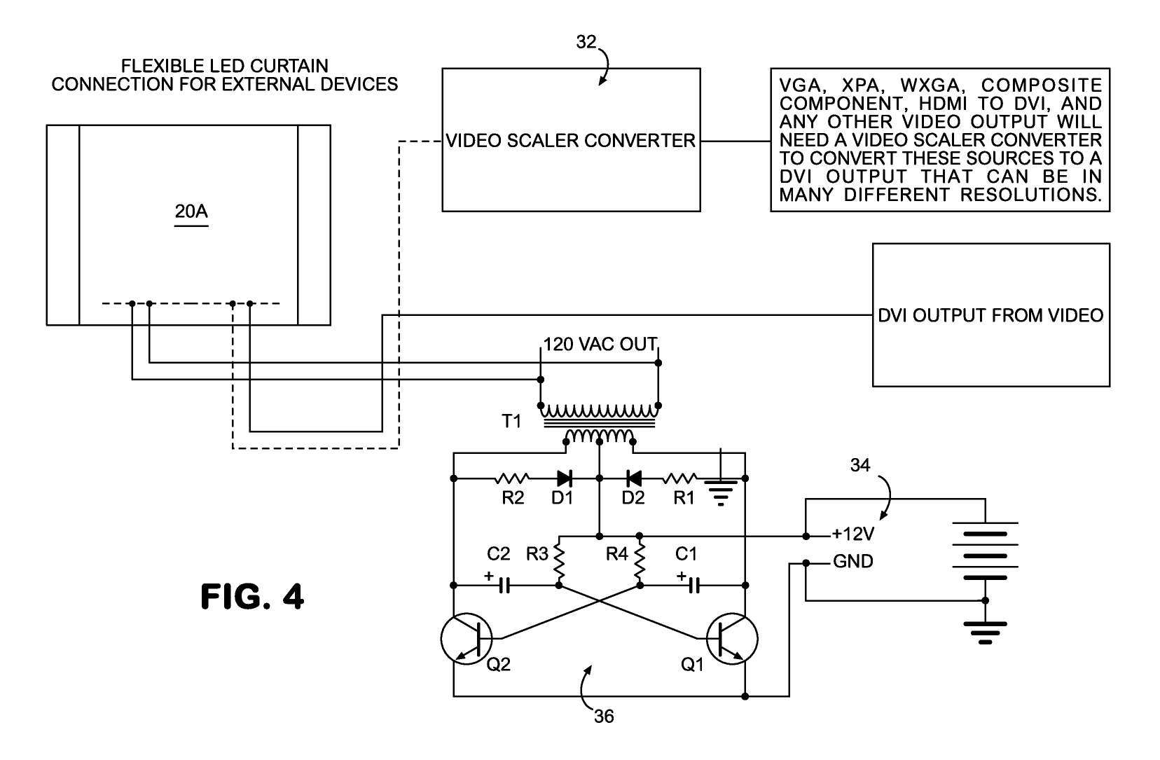

A block diagram of the external devices needed to support the flat screens 20 A & B is illustrated in FIG. 4. In this embodiment, the electrical power for the system is provided by the 12 volt DC battery 34 for the tractor. The system could have its own battery and generator (not shown). The battery 34 is connected to an external inverter 36, which includes capacitors C1 & C2, resistors R1 to R4, amplifiers D1 & D2 and transistors (NPN) Q1 & Q2. A step-up transformer T1 is needed to convert 12 volt DC input to 120 volt AC constant output to provide the correct power to the flat screen 20 A & B. The precise type of inverter that is needed depends upon the connected equipment.

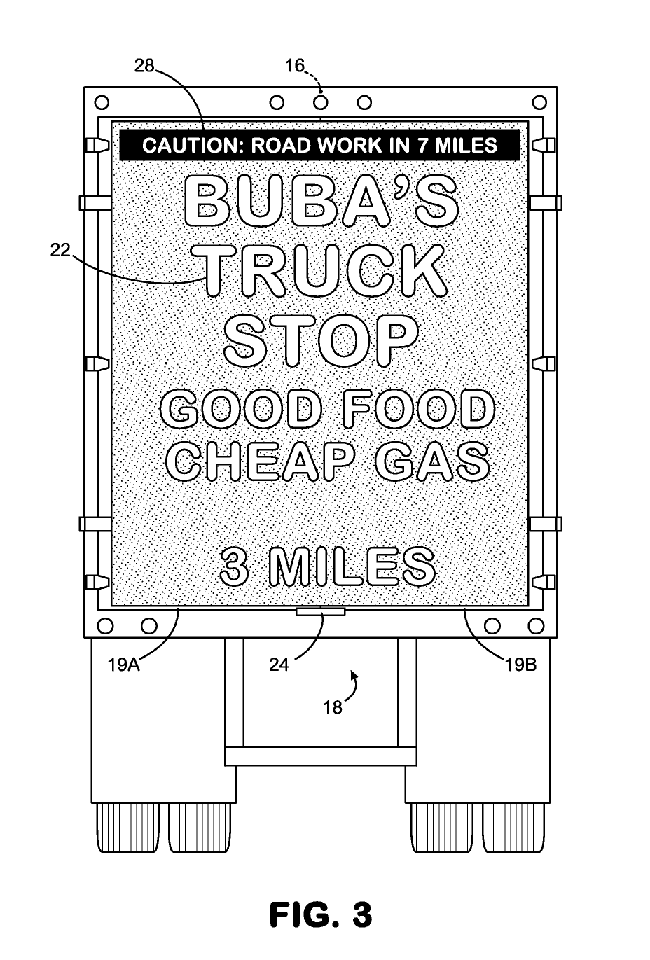

FIG. 3 illustrates an embodiment of this invention with a single wide flat screen 30 on the back 18 of a trailer. This screen is attached to one side of the back of the trailer, preferably one of the back doors 19 A & B. It is attached so the screen is outside of the door locking apparatus 24. The screen can be detachably attached to the other side of the trailer by a latch or other means. This screen 30 may be mounted on panel (not shown) to provide additional stability. The cable 16 extends to screen 30. This wide flat screen 30 can be attached to the roll-up door of a trailer. The screen 30 can be flexible and go up and down with the single roll-up door.

The system of this invention can be used on any moving vehicle, such as trailers of tractor trailer rigs, buses, taxis, ships, trains and subway cars.

In order to keep the display screens 20 A & B clean, a washer can be installed to wash the screen.

The system can be programmed to change the language of the message displayed, such as when the trailer is passing through a Latino area, which can be done either by the driver or the controller 14 based upon GPS information.

What is claimed is:

1. A system for displaying and periodically changing messages or images on a moving vehicle to be viewed by people outside the vehicle comprising an electronic display mounted on a moving vehicle for displaying messages or images, a GPS located on the vehicle, an electronic memory for storing messages or images to be displayed, an antenna and receiver and transmitter for communicating with the satellite of the GPS system and a wireless system for communicating with a central computer external to this system and a controller for controlling the system.

2. The system of claim 1 in which the display is located on the back or side of a trailer of a tractor trailer rig.

3. The system of claim 2 in which there are at least two displays on the back of the trailer.

4. The system of claim 2 in which there is a single display that extends across at least most of the back of the trailer.

5. The system of claim 1 further comprising a vehicle counter to count the number of vehicles within viewing distance of the vehicle on which the display is mounted and conveying that information to the controller for storing and processing for use in computing advertising rates.

6. The system of claim 1 in which a portion of the display is at least partially dedicated to displaying the stopping and turning actions of the vehicle.

7. The system of claim 1 in which a portion of the display is at least partially dedicated to displaying public announcements as received by the controller.

8. A method for presenting advertisements on a digital display on a moving vehicle comprising: determining the physical position of the vehicle using a GPS unit; presenting a first advertisement on the digital display; and periodically changing the advertisement based upon predetermined changes in the physical position of the vehicle using a GPS unit.

9. The method of claim 8 further comprising counting the number of vehicles within viewing distance of the display and utilizing this information in determining the charge to be paid by the advertiser.

10. The method of claim 8 further comprising displaying movement changes of the vehicle on a portion of the display.

11. Software for presenting advertisements on a moving vehicle operable to: determine a first physical location of the vehicle utilizing a GPS unit; presenting a first advertisement on a flat screen digital display on the vehicle; determine a second and subsequent physical locations of the vehicle using a GPS unit; and changing to different advertisements on the display.

12. The software of claim 11, further operable to: to communicate the physical location to a controller in the moving vehicle and to receive the advertisements from the controller and transmit to the digital display.

13. The software of claim 11, further comprising periodically communicating the physical location of the trailer to a central computer on the ground.
